(19) United States
(12) Patent Application Publication
(10) Pub. No.: US 2021/0049852 A1
(43) Pub. Date: Feb. 18, 2021

(54) OPTICAL PRODUCT CHECKING SYSTEM

(71) Applicant: Sensor Instruments Entwicklungs- und Vertriebs GmbH, Thurmansbang (DE)

(72) Inventors: Walter BRAUMANDL, Thurmansbang (DE); Andreas WINGARTZ, Weitnau (DE)

(21) Appl. No.: 16/608,619

(22) PCT Filed: Apr. 26, 2018
(86) PCT No.: PCT/EP2018/060784

§ 371 Date: Oct. 25, 2019

(30) Foreign Application Priority Data
Apr. 26, 2017 (DE) 10 2017 108 983.7

(51) Int. Cl. G07D 7/202; G07D 7/12

(52) U.S. Cl. CPC G07D 7/205; G07D 7/12

(57) ABSTRACT

An optical product checking system (100) for checking a property and an authenticity of a product (10) emits light from a plurality of light-emitting units (12, 14, 16, 18) toward a surface of the product (10). Respective intensities of light emanating from the surface of the product (10) in response to the emitted light are detected and used to determine the property and the authenticity of the product (10). The optical product checking system can be incorporated into a beverage-preparation system, for example, to determine whether a coffee capsule for a coffee machine is an authentic product of the manufacturer of the coffee machine.

### CROSS-REFERENCE

This application is the U.S. national stage of International Application No. PCT/EP2018/060784 filed on Apr. 26, 2018, which claims priority to German patent application no. 10 2017 108 983.7 filed on Apr. 26, 2017.

### TECHNICAL FIELD

The present invention generally relates to an optical product checking system and a device including such a product checking system, as well as to a packaging of a product to be checked by the product checking system.

### RELATED ART

An authentication method and an authentication system, which are used in connection with a packaging film for product authentication, are known from EP 2 318 286 B 1. The packaging film contains pigment particles that are present in a small amount in a random distribution in a surface of the packaging film. A product is packaged with a packaging film containing the randomly distributed pigment particles. Here, an Identcode is derived, according to an encryption algorithm, from the relative position coordinates and optionally the color values of the pigment particles and recorded. In an authentication, a digital image of the surface of the packaging film, which contains the pigment particles, is recorded using an imaging device. The digital image is evaluated by a computer, wherein a check code is derived from the relative position coordinates of N pigment particles that are different from one another, and optionally from the color values themselves, and is compared with recorded (stored) Identcodes to identify a closest match. For example, the Identcode comprises angle values of one or more polygons having m corners, wherein m is a natural number in the range of 3≤m ≤N and the coordinates of the polygons correspond to the relative position coordinates of m pigment particles. Pigment particles are used, for example, that exhibit luminescence in the wavelength range of 100 to 380 nm. Materials that fluoresce in the visible range when excited with UV light are particularly suitable, for example, particles that contain rare earth metals.

A device for a portable smart device for authenticating an object, which contains pigment particles that fluoresce in the visible range when excited with UV light, is known from DE 10 2015 005 304 B3. This device includes a UV illumination unit that enables the particles contained in the to-be-authenticated object to be excited with UV light, whereupon the fluorescence resulting therefrom in the visible range can be captured by a camera. For this purpose, the device includes a positioning apparatus that ensures the correct positioning of the camera with respect to the object to be authenticated.

### SUMMARY

One non-limiting object of the present teachings is to disclose an optical product checking system that is capable of determining a property and an authenticity of a product in a simple manner. In particular a product checking system is disclosed that can be installed in various devices in a simple manner, for example, in devices for preparing beverages such as coffee or tea. Furthermore, a packaging is disclosed that is suitable for use with such an optical product checking system.

According to one embodiment of the present teachings, an optical product checking system, which includes a plurality of light-emitting units that respectively emit light in different wavelength ranges toward a surface of a product to be checked, can be used in particular for a two-step checking of both a property, for example of a color or of a reflection behavior, and the authenticity of a product. For example, by using the plurality of light-emitting units, a color of a surface of the product or of a packaging thereof can be determined by inferring the color of the surface based on the respective intensities that, upon emission of light by the plurality of light-emitting units, are detected by a corresponding detection unit after reflection from the surface.

Furthermore, one of the plurality of light-emitting units can be energized such that it emits a light pulse having a predetermined duration and intensity. On this basis, it can be determined with reference to the temporal progression of the intensity of light, which is emitted by pigment particles in the product in response to excitation by the light pulse, whether the product has certain properties that indicate it is, for example, an original (authentic) product.

Such an optical product checking system may be utilized (installed), for example, in a beverage-preparation system that contains capsules as the product to be checked, using which a beverage is prepared. This makes it possible to determine the property, for example the content and/or the origin (manufacturer) of the capsule, without problem. Based on this, for example, appropriate parameters for preparing the beverage can be selected.

In another embodiment of the present disclosure, a reliable checking can be ensured owing to a packaging for a product, which packaging includes a carrier material made of a plastic and a plurality of pigment particles introduced into the carrier material. The pigment particles exhibit a luminescence when excited by the product checking system disclosed herein. High reliability can be achieved, in particular, by providing a relatively large number of the pigment particles. Furthermore, when a plurality of different pigment particles is used, various possibilities arise to determine the property and/or authenticity of the product.

Further features and utilities will be understood by reading the description of the following exemplary embodiments with reference to the Figures.

### BRIEF DESCRIPTION OF THE DRAWINGS

FIG. 1 shows a schematic illustration of an exemplary optical product checking system according to the present teachings.

FIG. 2 shows an enlarged view of a sensor unit of the product checking system in FIG. 1.

FIG. 3 shows a plurality of diagrams that depict a temporal sequence of emitted light pulses and the intensities detected in response thereto.

FIG. 4 shows diagrams that depict the behaviors of an original product and a counterfeited product, respectively, when excited with a light pulse.

FIG. 5 shows a schematic illustration of an optical capture (image) of pigment particles using a camera according to the present teachings.

FIG. 6 shows a schematic illustration of a beverage-preparation system that includes an optical product checking system according to the present teachings.

### DETAILED DESCRIPTION OF THE INVENTION

Examples of an optical product checking system, a beverage-preparation system, a packaging for a product to be checked, and a corresponding checking method are described below with reference to the Figures.

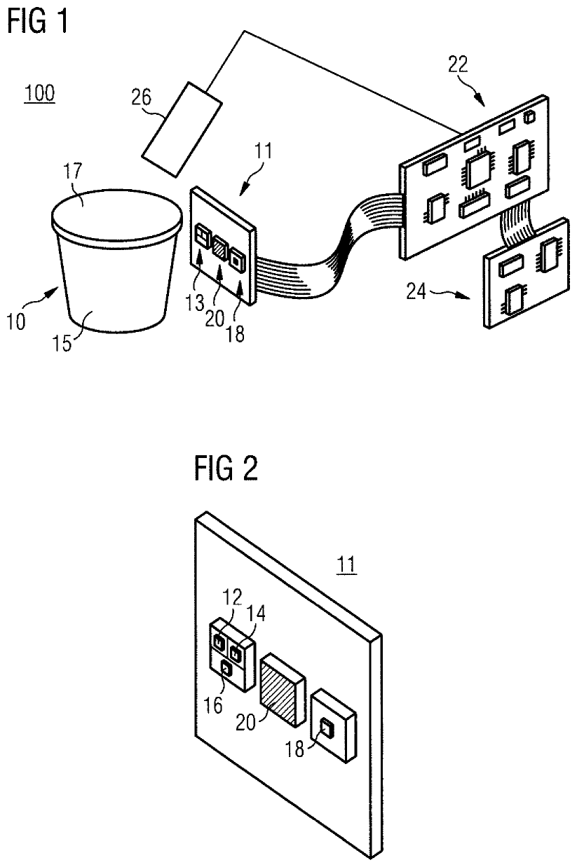

FIG. 1 shows a schematic illustration of an optical product checking system 100 according to the present disclosure. The product checking system 100 is to be used for checking a property and/or an authenticity of a product 10 to be checked, which is depicted in this example as a known coffee capsule. The coffee capsule includes, for example, a cup-type body 15 made of aluminum or plastic etc., that is closed by, for example, an aluminum film 17 and contains ground coffee in its interior. Because the design and use of such coffee capsules are well known, a description thereof is omitted herein.

The product checking system 100 includes a sensor unit 11 that is provided at a position at which it opposes the product 10, for example, the body 15 of the coffee capsule. The sensor unit 11 includes a plurality of light-emitting units, for example, a red LED 12, a green LED 14, and a blue LED 16 (see FIG. 2), which are combined in the present embodiment into an RGB LED 13, as well as a further light-emitting unit in the form of an IR LED 18. Furthermore, the sensor unit 11 includes a detection unit 20, for example, a photodiode.

The details of the exemplary sensor unit 11 are shown in more detail in FIG. 2. It is understood that any known light-emitting units that are capable of emitting light in a certain wavelength range can be used as the light-emitting units. In other words, the present disclosure is not limited to the use of a red LED, a blue LED, a green LED, and an IR LED. Any suitable detection element that is capable of detecting respective intensities of light that are emitted from the surface of the product in response to the light emitted from the light-emitting units can be used as the detection unit 20. As is explained below, the light emitted from the surface of the product can be light reflected on the surface or light emitted, due to luminescence, from pigment particles contained in the surface.

As shown in FIG. 1, the product checking system 100 further includes an evaluation unit 22 that can include various known electronic components that are mounted, for example, on a PCB and connected to the sensor unit 11 via a cable or the like. As is explained in more detail below, the evaluation unit 22 is configured to determine the color and/or the authenticity of the product 10 based on the intensities detected by the detection unit 20. The evaluation unit 22 is connected to a control unit 24, which is configured inter alia to control the plurality of light-emitting units, i.e., the LEDs 12, 14, 16, 18 such that they emit light toward the surface of the product 10. The control unit 24 can be a known control unit, such as a microcontroller, etc., having a CPU, a storage, and the like. It is understood that in some embodiments the evaluation unit 22 and the control unit 24 can be unitized, for example, as part of a not-shown control system of a checking device or the like that can execute the functions of the evaluation unit 22 and of the control unit 24 by using appropriate software.

Furthermore, in the present embodiment, an image-capture device 26, for example, a known camera, is provided in the optical checking system 100. The image-capture device 26 is configured to capture a (digital) image of the surface of the product 10 on which the light emitted by the light-emitting units impinges.

In the present embodiment the product 10 to be checked can be subjected to a two-stage check. Thus in a first step, a certain property of the product 10 can be checked or scanned; for example, a color of the body 15 of the coffee capsule can be determined, for example, based on a detected reflection behavior of the same. In addition thereto the authenticity of the product 10 can be checked in a second step, for example, by checking for the presence/absence of a certain security feature in and/or on the material that forms the body 15.

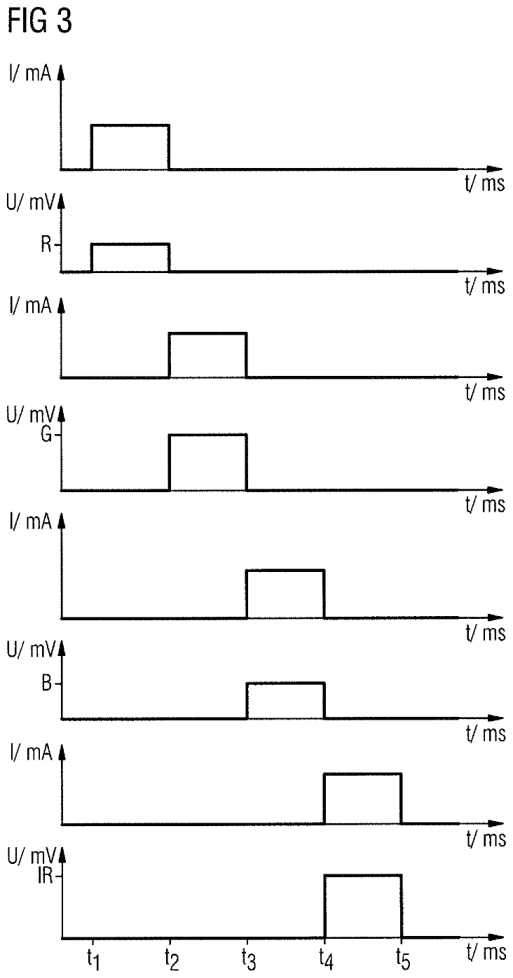

A first step for determining, for example, the color of the product 10 based on the reflection behavior is described in the following with reference to FIG. 3. As shown in FIG. 3, the control unit 24 is configured to energize the plurality of light-emitting units 12, 14, 16, 18 sequentially such that they respectively emit light for a certain period of time. Furthermore, the evaluation unit 22 is configured to detect the intensity of the light, which was emitted by one of the plurality of light-emitting units 12, 14, 16, 18 and then reflected back from the surface of the product 10, before the control unit energizes a next one of the light-emitting units.

In the example shown in FIG. 3, the control unit 24 initially energizes the red LED 12 with a certain (predetermined) current at time t₁ so that the surface of the body 15 of the coffee capsule is illuminated with red light (uppermost graph in FIG. 3) for a predetermined period of time, for example until time t₂. As shown in the second graph from the top in FIG. 3, a portion of the red light is reflected from the surface of the body 15 and detected by the detection unit 20, for example, as a voltage that is proportional to the intensity of the reflected light. The detected (reflected light) value R can be stored, for example, in the storage of the control unit 24 or in a storage of the evaluation unit 22.

At time t₂ the control unit 24 switches off the red LED 12. The control unit 24 subsequently switches on the green LED 14. This can be effected, for example, essentially simultaneously with the switching off of the red LED 12, as is shown for the sake of simplicity in the third graph from the top in FIG. 3. Of course, the lapsing of a predetermined time after the switching off of the red LED can also be awaited before the next, i.e., the green LED 14, is switched on. The detection unit 20 then detects the intensity of the reflected green light G and stores it (cf. the fourth graph from the top in FIG. 3). At time t₃ the green LED 14 is switched off and the blue LED 16 is switched on. The detection unit 20 detects the intensity B of the reflected blue light. This is shown in the fifth and sixth graph in FIG. 3.

At time t₄ the control unit 24 switches off the blue LED 16 and further switches on the IR LED 18. Subsequently thereto, the intensity of the reflected infrared light IR is detected by the detection unit 20 and stored. At time t₅ the control unit switches off the IR LED 24. This is depicted in the two lowermost graphs in FIG. 3.

Next, the evaluation unit 22 calculates from the detected intensities R, G, B, and IR, for example, a normalized intensity r, a normalized intensity g, a normalized intensity b, and a normalized intensity ir according to the following equations:

r=R/(R+G+B+IR) Equation 1

g=G/(R+G+B+IR) Equation 2

b=B/(R+G+B+IR) Equation 3

ir=IR/(R+G+B+IR) Equation 4

As is easily verifiable, it means:

ir=1−(r+g+b) Equation 4a

Furthermore, the evaluation unit 22 calculates the average value of the intensities MV according to the following equation:

MV=(R+G+B+IR)/4 Equation 5

In the present embodiment the evaluation unit 22 is configured to determine the property, i.e., the color of the product 10, based on the values b, g, r, ir, and MV calculated according to equations 1 to 5. For this purpose, reference values for the above-mentioned quantities can be stored, for example, in the storage of the evaluation unit 20 or in the storage of the control unit 24, in particular as a vector having 4 components, wherein the components, for example, respectively indicate reference values for r, g, b, and MV. Each of these vectors can be associated in advance with a certain reflection behavior, based on which, for example, the color of the product can be determined. In other words, the above-described measurements can be performed for differently colored products, for example, by the manufacturer, and can be stored as the reference vectors in the corresponding storage. By comparing the values determined by the evaluation unit 22 with all possible value combinations or vectors that are stored in the storage, the combination that has the greatest matching (correlation) with the values determined by the evaluation unit can be identified. For example, a distance of the vectors in the four-dimensional vector space in the present case can be calculated in a known manner and used as a measure for the matching analysis. Then, the reference vector, which has the smallest distance to the measured vector, indicates the property or color of the product 10. It can also be provided that, when no reference vector has a predetermined minimum distance to the measurement vector, it is determined that an unknown color is present, whereupon it is reacts with an appropriate measure.

Even though the use of five measurement values or the controlling of four light-emitting units was described in the preceding, it is understood that the present invention is not limited thereto. For example, the calculation of the average value can be omitted. Furthermore, depending on the application, it can be sufficient to use only three or two light-emitting units in order to determine the property or color of the product 10. On the other hand, of course more than four light-emitting units can also be used in order to carry out the corresponding calculations. The number of values, based on which the comparison is performed, is also not limited to four and can be, for example, 2, 3 or 5.

After the color of the coffee capsule has been determined in the above-described manner, the control unit 24, which can be, for example, a general control unit of a beverage-preparation system to be used with the capsule, can control the beverage-preparation system in a corresponding manner in order, for example, to select the manner of preparation that corresponds to the color of the coffee capsule.

In addition to the above-described identification of the color of the product 10, the origin or authenticity thereof can also be determined in a second step. That is, in this step, the manufacturer of the product 10 can be inferred, or it can be determined whether the product originates from a certain manufacturer, in particular the manufacturer of the corresponding device.

For this purpose, the product 10, for example, the body 15 or the surface of the coffee capsule, can include pigment particles that exhibit luminescence. The pigment particles can be attached onto and/or embedded into the surface of the body 15 when manufacturing the body 15 or the product 10. In one example, the pigment particles can contain so-called up-converters that, when excited in the wavelength range between 900 nm and 1000 nm, exhibit a secondary emission in the wavelength range between 700 nm and 1050 nm. Suitable up-converters are known such that a description thereof is omitted herein. The particles can be provided in a sufficient number; for example, more than 100 pigment particles per cm² can be provided with an average pigment size between 2μm and 20μm, and can be present in a random or non-random (e.g., orderly) distribution.

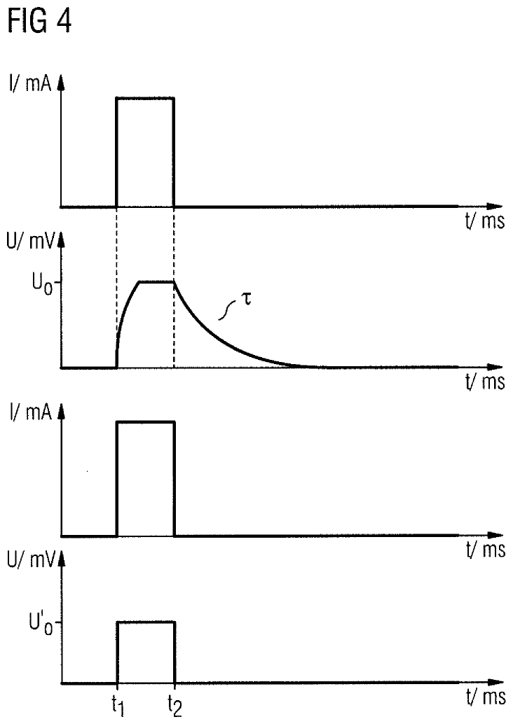

The control unit is configured to energize the IR LED 18, which is one of the plurality of light-emitting units, such that an infrared light pulse having a predetermined duration and intensity is emitted. The evaluation unit 22 is then configured to determine an initial intensity and/or a time constant of a decay behavior of the luminescence, for example, of the up-converters in the product 10 based on a temporal progression of the intensity detected by the detection unit 20. Based on the initial intensity and/or the time constant, the authenticity of the product 10, i.e., whether the product 10 originates from the original manufacturer, can then be determined. This is explained in more detail in the following with reference to FIG. 4.

As shown in FIG. 4, at time t₁ the control unit 24 is configured to energize the IR LED 18 so as to emit a light pulse having a certain intensity and duration. For example, the light pulse can be emitted for the duration t₂-t₁, as is shown in the uppermost graph in FIG. 4.

As a result thereof, the pigment particles contained in the product 10 are thereupon excited and fluoresce with a certain characteristic behavior that is shown, for example, in the second graph from the top in FIG. 4. In other words, at time t₂ the detected intensity has an initial intensity U₀ that decreases exponentially with a certain (known) time constant τ. Using the temporal progression of the intensities detected by the detection unit 20, the initial intensity U₀ and the time constant τ can be determined. These values can then be compared to values stored in the storage of the evaluation unit 22 or of the control unit 24. The stored values correspond to the material used by the original manufacturer or to the pigment particles used by the original manufacturer. The evaluation unit 22 can then, for example, determine whether the product 10 originates from the original manufacturer or not based on whether the initial intensity U₀ and/or the time constant τ fall(s) within prescribed ranges.

The lower two graphs in FIG. 4 show the case in which an original product is not used or checked. In this case, the same pulse is emitted by the IR LED 18, but a lower initial intensity U₀′ or no decay behavior is observed. In other words, the evaluation unit 22 determines that the initial intensity U₀′ does not fall within the prescribed range, or the time constant τ also does not fall within the prescribed range. In this way the evaluation unit 22 can determine that it is not an original (authentic) product.

In other embodiments, the property, i.e., the color of the product, can optionally be further identified with consideration of the initial intensity and/or of the decay behavior of the luminescence. For example, a vector having 4, 5, 6, or 7 components can be formed from a suitable combination of the intensities r, g, b, ir, the average value MV, the initial intensity U₀ and the time constant τ. The vector is then used with the corresponding reference value vectors for determining the property in the manner described above. In one example, the combination of r, g, b, MV can be used. In another example, the combination of r, g, b, MV, τ, U₀ can be used.

In further embodiments, the property can also be determined by making a preselection with regard to the property (e.g., type of the product) based, for example, on the initial intensity and/or the time constant and then, more precisely determining the property (e.g. which product it is) based on the intensities, e.g., r, g, b, MV. Alternatively the preselection can also be made based on the intensities, and the property can be determined more precisely based on the initial intensity and/or time constant.

Even though the use of up-converters or the IR LED 18 was described in the preceding, the checking of the authenticity alternatively or additionally can also be performed in another manner. This is explained in more detail in the following with reference to FIGS. 1 and 5.

As mentioned above, in the present embodiment the product checking system 100 further includes an image-capture device 26 that is configured to capture an image of the surface of the product 10, which illuminated by the light-emitting units 12, 14, 16, 18. In particular, the control unit 24 can be configured to energize a certain one of the plurality of light-emitting units 12, 14, 16, 18 such that it emits a light pulse with an elevated intensity for a predetermined period in order to excite pigment particles, which exhibit a luminescence, in or on the surface of the product 10 in this way. As is explained in more detail below, the evaluation unit 22 can be configured to determine, based on an image captured by the image capture device 26, a total quantity, positions, and/or a positional relationship of the excited particles, and to determine based thereon the authenticity of the product 10.

For example, alternatively or in addition to the above-described up-converters, the body 15 of the coffee capsule can contain so-called down-converters that exhibit a secondary emission in the visible range (e.g., yellow, orange, or red) when excited in the UV range, but also in particular in the blue wavelength range (in wavelengths between approximately 420 nm and approximately 490 nm). Particles of the Lumilux® brand from the company Honeywell® are an example of such particles. That is, in the present case the control unit 24 is configured to energize the blue LED 16 such that a light pulse having a high intensity is emitted for a predetermined period of time. This can induce fluorescence of the down-converters in the visible range that can be detected or captured by the image-capture device 26. An image 27 captured by the image-capture device 26 is shown in FIG. 5. As shown in FIG. 5, the non-excited carrier material 30 of the body 15 can be seen in the image 27. In addition, the excited or fluorescing particles 29 or 31 also can be seen. Thus, as shown in FIG. 5 two different types of particles may be utilized together. For example, in addition to the above-mentioned down-converters 29, additional down-converters 31 that can also be excited in the blue wavelength range can be used, but which, for example, have a secondary emission in a wavelength range different from the first down-converters. For example, the additional down-converters can exhibit a secondary emission in the blue wavelength range. The total number of pigment particles 29, 31 is greater than 100 per cm², wherein, for example, the number of particles 29 exhibiting a secondary emission in a certain wavelength range (e.g., above 550 nm) is smaller than 100 per cm². As an alternative to the down-converters 29, particles can also be used, for example, that are only excitable in the blue wavelength range and exhibit a secondary emission in the yellow, orange, or red range, e.g., particles of the spectroTAG® brand from the company U-NICA®.

The evaluation unit 22 is thus configured to determine, based on the image 27, the number and/or the positions or positional relationships of the particles excited in the wavelength range of 400 nm to 490 nm, which particles exhibit a secondary emission in a certain wavelength range in the captured image area prescribed by the positioning or optics of the image-capture device 26. In order to be able to carry out a determination using the image-capture device 26 in a problem-free manner, the number of these particles should not be too large, e.g., less than 200 per cm², in particular less than 100 per cm², even though the pigment particles can be provided in a total count of more than 100 or 200 per cm². Preferably less than 100 pigment particles exhibiting a secondary emission in the certain wavelength range per cm² are used in order to keep the calculating effort during the detection of the excited particles within limits. For the case that further additional particles are provided having a secondary emission that does not fall in the prescribed wavelength range, they can be filtered out in a suitable manner using one or more filters 28 before the image-capture device 26 (cf. FIG. 5).

From the prescribed number of particles 29 or 31, it can then be determined in a different manner whether the number matches a number associated with an original product. Various combination possibilities are conceivable here. For example, by providing the filter 28 and/or suitable evaluation algorithms, only the particles 29 can be counted. Under certain circumstances the particles 31 can additionally also be counted, e.g., by providing different filters, etc. Alternatively the particles can also differ from one another and be counted by comparison of the brightness- or gray-values or in other known ways. In a further alternative, the total number of the particles 29 and 31 can also be determined. In a first case a ratio of the number of the particles 29 to the number of the particles 31 can also be determined. All values thus determined can be used individually or in combination with one another for the comparison with stored reference values. The evaluation unit 22 is configured to determine, based on the prescribed particle-numbers or -ratios, whether the material that is used for the product 10 or the packaging thereof has the properties prescribed by the original manufacturer.

It is understood that the above description is only exemplary. Thus a blue LED need not necessarily be used for excitation of the particles 29 and/or 31. Optionally, particles can also be used that fluoresce or phosphoresce in different wavelength ranges when excited and can be detected by the image-capture device 26. Furthermore, two or more light-emitting units can also be used in order to, for example, successively excite the respective particles. The filters 28 used can also be suitably selected. For example, a long-pass filter can be used that is almost transparent starting from 550 nm, but is almost not transparent below 550 nm. Furthermore, even though an example has been described in connection with FIG. 5 wherein two different pigment particles have been used, three or more different pigment particles can also be used. It is also possible to use only a single type of pigment particles in order to determine the number of excited particles using the image capture device.

In addition or alternatively to the number of excited particles exhibiting a secondary emission in a prescribed wavelength, it is also possible to determine a positional relationship of the excited particles to one another in order to thus determine the authenticity of the product 10. For example, the method mentioned in the above-mentioned EP 2 318 286 B1 can be used in order to determine the positional relationship of the particles to one another or the corresponding triangles.

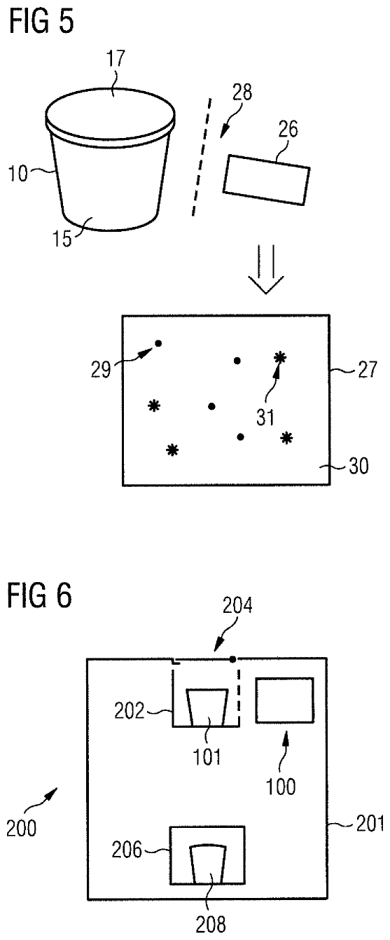

As mentioned above, the optical product checking system disclosed herein is suited in particular for use with a beverage-preparation system 200, which is shown in FIG. 6. As shown in FIG. 6, the beverage-preparation system 200 includes a housing 201 that includes a receptacle 202 for holding a capsule 101, which receptacle 202 is closable, for example, by a cover 204. A capsule 101 can be inserted by a user of the system 200 into the receptacle 202 in order to prepare a beverage. However, before the preparation of the beverage, the color and/or the origin or the authenticity, for example, of the capsule 101 can be determined by the optical product checking system 100 explained above. In one example, the type of the capsule, i.e., the exact type of the beverage to be prepared, can be inferred, for example, based on the intensities (which indicate the color of the capsule) and optionally further the time constant or the initial intensity of the luminescence. In accordance with the determination, the preparation of the beverage from the capsule 101 can then be carried out in a suitable manner by the beverage-preparation system 200 or optionally also can be disallowed. The prepared beverage can then be filled into a container 208, for example, a cup or a glass that is positioned in a removal region 206.

It is understood that the product checking system 100 disclosed herein can be used in a suitable manner in a variety of different beverage-preparation systems. For example, the sensor unit 11 can be provided at a suitable position and connected to a central control unit of the beverage-preparation system in order to carry out the measurements described herein. The same also applies to the camera 26 if it is present. The pigment particles mentioned herein can, as described, be provided in or on the body of the capsule 101, or also in or on the film 17 closing the body. For example, the particles can be contained in a transparent film that is applied, for example, to a previously colored aluminum film and/or to the body 15 or laminated thereto. Alternatively thereto, the particles can already be applied with a printing ink, for example, by admixing the pigment particles into the printing ink or printing paste before a printing process. Of course, other types of capsules can also be used, provided they include the pigment particles at a suitable position of their surface. Furthermore, the detection by the product checking system 100 need not be carried out at the position at which the capsule 101 is positioned in the receptacle 202; rather it can also be carried out at other positions, for example, on a supply path to the receptacle 202.

Even though the use of the optical product checking system disclosed herein has been described in detail in the preceding in connection with a beverage-preparation system 200, it is understood that the product checking system 100 can also be used for checking a property and/or an authenticity of other products. For example, packaging of medications and the like, e.g., so-called blister packages, can be checked for their authenticity by the system disclosed herein.

Such a packaging is, for example, a plastic film that surrounds a product 10. The plastic film includes a carrier material 30 and a plurality of pigment particles 29, 31 introduced into the carrier material 10. The pigment particles exhibit luminescence when excited by light in the blue and/or ultraviolet spectral range or also in the infrared spectral range (cf. FIG. 5). In order to ensure a reliable detection, the total number of the pigment particles is also more than 100 per cm², preferably more than 200 per cm², wherein however it can also be provided in this case that the number of particles exhibiting a secondary emission in a prescribed wavelength range is limited to, for example, less than 100 per cm².

In particular, the plurality of pigment particles in the packaging can include up-converters excitable in the infrared range, which up-converters can be detected in the above-described manner by excitation using, for example, an IR diode.

Alternatively or additionally thereto, as was already described, the plurality of pigment particles can include a first plurality of first pigment particles 29 and a second plurality of second pigment particles 31 that are different from the first pigment particles. For example, as described above, a combination of up-converters and down-converters, a combination of two different down-converters, a combination of up-converters and particles of the brand spectroTAG®, etc. can be used in order to determine, using the image-capture device 26 in the above-described manner, a total number of excited particles exhibiting a secondary emission in a prescribed wavelength range, a ratio of numbers of excited particles, a state of excited particles with respect to one another, etc., in order to thus infer the authenticity of the product 10 enclosed by the packaging. Furthermore it is also possible to provide only one type of pigment particles that can be excited in the visible wavelength range between approximately 380 nm and 750 nm, for example also limited to less than 100 per cm².

It is explicitly emphasized that all of the features disclosed in the description and/or the claims should be considered as separate and independent from one another for the purpose of the original disclosure as well as for the purpose of limiting the claimed invention, independent of the combinations of features in the embodiments and/or the claims. It is explicitly stated that all range specifications or specifications of groups of units disclose every possible intermediate value or subgroup of units for the purpose of the original disclosure as well as for the purpose of limiting the claimed invention, in particular also as the limit of a range specification.

Further aspects of the present disclosure include but are not limited to:
1. Optical product checking system (100) for checking a property and/or an authenticity of a product (10), including

a plurality of light-emitting units (12, 14, 16, 18) that are configured for emitting light in respectively different wavelength ranges toward a surface of the product (10) to be checked,

a control unit (24) that is configured to energize the plurality of light-emitting units (12, 14, 16, 18) such that they emit light,

a detection unit (20) that is configured to detect respective intensities of light emitted (emanating) from the surface of the product (10) in response to light emitted from the respective light-emitting units (12, 14, 16, 18), and

an evaluation unit (22) that is configured to determine the property and/or the authenticity of the product (10) based on the intensities detected by the detection unit (20).
2. Product checking system according to the above-mentioned Aspect 1, wherein the control unit (24) is configured to energize the plurality of light-emitting units (12, 14, 16, 18) sequentially so that they each successively emit light for a certain period of time, and

wherein the evaluation unit (22) is configured to detect the intensity for one of the plurality of light-emitting units (12, 14, 16, 18) before the control unit (24) energizes a next one of the light-emitting units (12, 14, 16, 18).
3. Product checking system according to the above-mentioned Aspect 2, wherein the evaluation unit (22) compares the intensities detected by the detection unit (20) to reference value vectors that are each associated with a certain reflection behavior, in order to determine the reflection behavior of the product (10) based on the reference value vector having the greatest (closest) matching.
4. Product checking system according to the above-mentioned Aspect 3, wherein the evaluation unit is configured to determine, and take into account in the comparison, the average value of all detected intensities.
5. Product checking system according to any one of the above-mentioned Aspects 1 to 4, wherein the evaluation unit (22) is configured to normalize the detected intensities with respect to the sum of all detected intensities.
6. Product checking system according to any one of the above-mentioned Aspects1 to 5, wherein the light-emitting units (12, 14, 16, 18) include at least one red LED, one blue LED, one green LED, or one IR LED.
7. Product checking system according to any one of the above-mentioned Aspects 1 to 6,

wherein the control unit is configured to energize a first of the plurality of light-emitting units (12, 14, 16, 18) such that a light pulse having a predetermined duration and intensity is emitted, and

wherein the evaluation unit (22) is configured to determine, based on the temporal progression of the intensity detected by the detection unit (20), an initial intensity and/or a time constant of a decay behavior of the luminescence of particles in the product and to determine the authenticity of the product (10) based on the initial intensity and/or the time constant.
8. Product checking system according to the above-mentioned Aspect 7, wherein the evaluation unit (22) determines that the product (10) is authentic when the initial intensity and the time constant each fall within prescribed ranges.
9. Product checking system according to the above-mentioned Aspect 7 or 8, wherein the first of the plurality of light-emitting units (12, 14, 16, 18) is an IR LED.
10. Product checking system according to any one of the above-mentioned Aspects 1 to 9, further including an image-capture device (26) that is configured to record an image of the surface of the product (10),

wherein the control unit is configured to energize a second of the plurality of light-emitting units (12, 14, 16, 18) such that it emits light having an increased intensity for a predetermined duration in order to excite particles in the surface of the product (10), and wherein the evaluation unit (22) is configured to determine, based on an image captured by the image-capture device (26), a total number, positions, and/or a positional relationship of the excited particles, and based thereon determine the authenticity of the product (10).
11. Product checking system according to the above-mentioned Aspect 10, wherein the second of the plurality of light-emitting units (12, 14, 16, 18) is a blue LED or a UV light source.
12. Product checking system according to the above-mentioned Aspect 10 or 11, further including a filter (28) that is disposed between the product (10) and the image-capture device (26) such that only light in a selected wavelength range reaches the image-capture device (26).
13. Beverage-preparation system (200) including

an optical product checking system (100) according to any one of the above-mentioned Aspects 1 to 12, and

a receptacle (202) for the product (10),

wherein the product checking system (100) is configured to determine the property and/or the authenticity of the product (10) held in the receptacle (202) before the preparation of a beverage from the product (10).
14. Packaging for a product (10), including

a carrier material (30) made of plastic or metal, for example, aluminum, and

a plurality of pigment particles (29, 31) introduced into and/or applied onto the carrier material, which pigment particles (29, 31) exhibit luminescence when excited by light in the visible, in particular blue, and/or ultraviolet or infrared spectral range,

wherein the total number of all pigment particles is more than 100 per cm², preferably between 200 and 600 per cm².
15. Packaging according to the above-mentioned Aspect 14, wherein the plurality of pigment particles includes up-converters (29) that are excitable in the infrared range.
16. Packaging according to the above-mentioned Aspect 14 or 15, wherein the plurality of pigment particles includes a first plurality of first pigment particles (29) and a second plurality of second pigment particles (31) that are different from the first pigment particles.
17. Packaging according to the above-mentioned Aspect 16, wherein at least the first pigment particles (29) or the second pigment particles (31) are, for example, down-converters that emit light in the visible wavelength range when excited.
18. Packaging according to the above-mentioned Aspect 16, wherein the number of at least the first pigment particles or the second pigment particles is less than 100 per cm².
19. Packaging for a product (10), including

a carrier material (30) made of plastic or metal, for example, aluminum, and

a plurality of pigment particles (29, 31), excitable in the visible wavelength range, exhibiting a secondary emission in the visible, in particular yellow, orange or red, spectral range, which pigment particles (29, 31) are introduced into and/or applied onto the carrier material (30),

wherein the number of pigment particles (29, 31) is less than 200 per cm², preferably less than 100 per cm².

20. Method for checking a property and/or an authenticity of a product (10), including

emitting of light in respectively different wavelength ranges toward a surface of the product (10) to be tested,

detecting of respective intensities of light emitted from the surface of the product (10) in response to the light emitted in the different wavelength ranges, and

determining the property and/or the authenticity of the product (10) based on the detected intensities.

1. An optical product checking system for checking a property and an authenticity of a product including:
a plurality of light-emitting units configured to emit light in respectively different wavelength ranges toward a surface of the product,
a control unit configured to energize the plurality of light-emitting units such that the plurality of light-emitting units emit light,
a detection unit configured to detect respective intensities of light emanating from the surface of the product in response to light emitted from each one of the light-emitting units, and
an evaluation unit configured to determine the property of the product based on the detected intensities,
wherein the control unit is further configured to energize a first one of the plurality of light-emitting units such that a light pulse having a predetermined duration and intensity is emitted, and
the evaluation unit is configured to determine, based on a temporal progression of the detected intensities, an initial intensity or a time constant of a decay behavior of a luminescence of particles in the product and to determine the authenticity of the product based on the initial intensity or the time constant.

2. The optical product checking system according to claim 1, wherein:
the control unit is configured to energize the plurality of light-emitting units sequentially so that the light-emitting units each successively emit light for a predetermined period of time, and
the evaluation unit is configured to detect the intensity of light emanating from the surface of the product in response to light emitted from each one of the plurality of light-emitting units before the control unit energizes a next one of the light-emitting units.

3. The optical product checking system according to claim 1, wherein the evaluation unit is further configured to determine the property of the product based on the initial intensity or the time constant

4. The optical product checking system according to claim 2, wherein the evaluation unit is configured to:
compare the detected intensities to stored reference value vectors, and in order to
determine the property of the product based on which of the stored reference value vectors has the greatest matching with the detected intensities in order to determine the property of the product.

5. The optical product checking system according to claim 3, wherein the evaluation unit (22) is configured to either:
make a preselection with respect to the property based on the initial intensity or the time constant, and subsequently to determine the property in more detail based on the detected intensities, or
make a preselection with respect to the property based on the detected intensities, and subsequently determine the property in more detail based on the initial intensity or the time constant.

6. The optical product checking system according to claim 1, wherein the evaluation unit is configured to normalize the detected intensities with respect to a sum of all of the detected intensities.

7. The optical product checking system according to claim 1, wherein the evaluation unit is configured to determine that the product is authentic when the initial intensity and the time constant each fall within prescribed ranges.

8. The optical product checking system according to claim 1, wherein the first one of the plurality of light-emitting units is an IR LED.

9. The optical product checking system according to claim 1, further including:
an image-capture device configured to capture an image of the surface of the product,
wherein the control unit is configured to energize a second one of the plurality of light-emitting units such that it emits light having an increased intensity for a predetermined duration in order to excite particles in the surface of the product, and
the evaluation unit is configured to determine, based on the image captured by the image-capture device, a total number, positions, or a positional relationship of the excited particles, and based thereon determine the authenticity of the product.

10. The optical product checking system according to claim 9, wherein the second one of the plurality of light-emitting units is a blue LED or a UV light source.

11. The optical product checking system according to claim 9, further including:
a filter arranged to be disposed between the product and the image-capture device such that only light in a selected wavelength range reaches the image-capture device.

12. A beverage-preparation system (200) including:
the optical product checking system according to claim 1, and
a receptacle for holding the product,
wherein the evaluation unit is configured to determine the property and the authenticity of the product while the product is being held in the receptacle before initiating preparation of a beverage from the product.

13. A packaging for a product for use in an optical product checking system according to claim 1, including:
a carrier material made of plastic or metal, for example, and
a plurality of pigment particles disposed in or on the carrier material, the pigment particles exhibiting luminescence when excited by light in the visible, ultraviolet or infrared spectral range,
wherein the total number of all pigment particles is more than 100 per cm².

14. The packaging according to claim 13, wherein the plurality of pigment particles includes up-converters that are excitable in the infrared range.

15. A method for checking a property and an authenticity of a product, including:
emitting light in respectively different wavelength ranges toward a surface of the product,
detecting respective intensities of light emanating from the surface of the product in response to the light emitted in the different wavelength ranges,
determining the property of the product based on the detected intensities,
emitting a light pulse having a predetermined duration and intensity in a first one of the different wavelength ranges,
detecting a temporal progression of the intensities of the light that emanate from the surface of the product in response to the light pulse,
determining an initial intensity or a time constant of a decay behavior of luminescence of particles in the product based on the temporal progression of the detected intensities, and
determining the authenticity of the product based on the initial intensity or the time constant.

16. The method according to claim 15, wherein:
both the initial intensity and the time constant of the decay behavior of luminescence of the particles in the product are determined based on the temporal progression of the detected intensities, and
the authenticity of the product is determined based on both the initial intensity and the time constant.

17. The optical product checking system according to claim 1, wherein the evaluation unit is configured to:
determine, based on the temporal progression of the detected intensities, both the initial intensity and the time constant of the decay behavior of luminescence of the particles in the product,
determine the property of the product based on both the initial intensity and the time constant, and
determine the authenticity of the product based on both the initial intensity and the time constant.

18. The optical product checking system according to claim 17, wherein:
the control unit is configured to sequentially energize the plurality of light-emitting units so that the light-emitting units each successively emit light for a predetermined period of time, and
the evaluation unit is configured to:
detect the intensity of light emanating from the surface of the product in response to light emitted from each one of the plurality of light-emitting units before the control unit energizes a next one of the light-emitting units,
compare the detected intensities to stored reference value vectors, and
determine which of the stored reference value vectors has the greatest matching with the detected intensities in order to determine the property of the product.

19. The optical product checking system according to claim 18, further including:
an image-capture device configured to capture an image of the surface of the product,
wherein the control unit is configured to energize a second one of the plurality of light-emitting units such that it emits light having an increased intensity for a predetermined duration in order to excite particles in the surface of the product, and
the evaluation unit is configured to determine, based on the image captured by the image-capture device when the second one of the plurality of light-emitting units emits light, a total number, positions, or a positional relationship of excited particles, and based thereon determine the authenticity of the product.

20. The optical product checking system according to claim 19, wherein:
the first one of the plurality of light-emitting units is an infrared LED,
the second one of the plurality of light-emitting units is a blue LED or a UV light source, and
the evaluation unit is configured to determine that the product is authentic when the initial intensity and the time constant both fall within respective prescribed ranges.
